(19) United States
(12) Patent Application Publication
(10) Pub. No.: US 2011/0030213 A1
(43) Pub. Date: Feb. 10, 2011

(54) HYDRAULIC INSTALLATION TOOL FOR PUMP PLUNGER

(75) Inventors: John Hawes, Southlake, TX (US); Ed Kotapish, Willow Park, TX (US)

Correspondence Address: BRACEWELL & GIULIANI LLP, P.O. BOX 61389, HOUSTON, TX, 77208-1389, US

(73) Assignee: WEIR SPM, INC., Fort Worth, TX (US)

(21) Appl. No.: 12/852,376

(22) Filed: Aug. 6, 2010

Related U.S. Application Data
(60) Provisional application No. 61/232,269, filed on Aug. 7, 2009.

(51) Int. Cl. B23P 15/00; B23P 19/00

(52) U.S. Cl. 29/888.02; 29/700

(57) ABSTRACT

A hydraulic plunger installation tool that exerts a hydraulic force on a plunger for a reciprocating pump to install the plunger into a pump cylinder opening. Maintenance of the pump typically includes repacking of the packing that surrounds the plunger and revalving of the pump's inlet and outlet valve. To allow repacking or revalving, the pump is disassembled and the plunger is removed. The hydraulic plunger installation tool is located at the pump cylinder on an upward facing nest with legs that provide a reaction point for a hydraulically actuated piston rod that is driven at one end by a hydraulic piston and engages the plunger at an opposite end during installation to push the plunger into the cylinder opening without the use of hammers by personnel.

### CROSS-REFERENCE TO RELATED APPLICATION

This application claims priority to provisional application 61/232,269, filed Aug. 7, 2009.

### FIELD OF THE INVENTION

This invention relates in general to plungers used in reciprocating pumps, and, in particular, to a hydraulic tool for installing a plunger.

### BACKGROUND OF THE INVENTION

Various kinds of pumps can be used in oilfield operations. One type of pump, for example, is a reciprocating pump. The reciprocating pump can be used to pump fluid such as chemicals, cement, or other media into a well. Reciprocating pumps typically increase the pressure within a cylinder by reciprocating a plunger longitudinally within the cylinder. Packing is generally used around the plunger and the plunger reciprocates as a crankshaft located within the pump rotates. As the plunger moves away from the cylinder, the pressure of the fluid inside chamber decreases creating a differential pressure across an inlet valve that allows the fluid to enter the cylinder. As plunger moves longitudinally towards the cylinder, the pressure of the fluid inside of the cylinder increases until the differential pressure across an outlet valve opens the outlet valve and allows fluid to exit cylinder.

Maintenance of the pump, typically includes repacking of the packing surrounding the plunger and revalving of the inlet and outlet valves mentioned above. To allow repacking or revalving, the pump is disassembled by removing a suction cover plate and removing the plunger, which can be quite heavy. Additional pump components, such as connecting rods and pony rods may need to be stroked out to push out the plunger. However, during assembly of the pump, the plunger must be reinstalled. The plunger is heavy and requires much effort to push it back into the cylinder through the packing elements. Frequently, installing the plunger requires maintenance personnel to hammer the plunger into place during installation, potentially damaging pump parts or injuring personnel.

Thus, installation of the plunger into the cylinder is time consuming, labor intensive, and potentially unsafe to personnel.

Thus, a technique would be desired that makes pump maintenance and plunger installation safer, less time consuming, and less labor intensive.

### SUMMARY OF THE INVENTION

In an embodiment of the present invention, a hydraulic rod plunger installation tool is connected to a pump after maintenance is complete. The tool includes a piston and a piston rod that extends into a cylinder opening. The cylinder opening is covered by a suction cover plate during operation and has threads on an interior surface. A rail can be temporarily attached to the cylinder opening on which the hydraulic piston can be secured during the installation of the plunger, providing a reaction point for the piston. The tool further comprises a plurality of legs attached to the piston that engage the rail during installation of the plunger.

In an embodiment of the present invention, the piston rod of the hydraulic plunger installation tool further comprises a plurality of telescoping stages such that one stage is embedded within another stage and have a combined area of A1. The hydraulic piston rod may generate sufficient force, in an example, at least 1000 lbs, to push the plunger into the packing. The piston rod has an end that can engage the plunger to thereby transfer a distributed force axially the plunger.

During installation of the plunger the plunger is placed at the cylinder opening and the hydraulic plunger installation tool is mounted onto the pump. Hydraulic fluid can be connected to the cylinder of the tool to provide hydraulic power that can be exerted on the piston rod and consequently on the plunger. The installation tool advantageously generates sufficient force, in one example at least 1000 psi, to push the plunger into place. Once the plunger is properly in place within the pump cylinder, the hydraulic installation tool can be backed out of the cylinder opening and the plunger installation tool can then be removed for storage, allowing the suction cover plate to be placed back on the cylinder opening.

The hydraulic plunger installation tool thus advantageously provides a safer way to maintain and disassemble pumps because the plunger installation tool, rather than a hammer, can be used to push the plunger back into position within the pump cylinder. This also results in a less time consuming, potentially less damaged parts, and a less labor intensive method of maintaining and disassembling the pumps as hammering of the heavy plunger is eliminated.

### BRIEF DESCRIPTION OF THE DRAWINGS

FIG. 1 is an illustration of a reciprocating pump in the prior art;

FIG. 2 is an illustration of the plunger location within the cylinder portion of the pump shown in FIG. 1;

FIG. 3 is an enlarged perspective view of one embodiment of the hydraulic tool used to install the plunger back into the cylinder opening, constructed in accordance with the invention.

FIG. 4 is an illustration of one embodiment of the hydraulic tool in a retracted position, constructed in accordance with the invention.

FIG. 5 is an illustration of one embodiment of the hydraulic tool in an extended position, constructed in accordance with the invention.

### DETAILED DESCRIPTION OF THE INVENTION

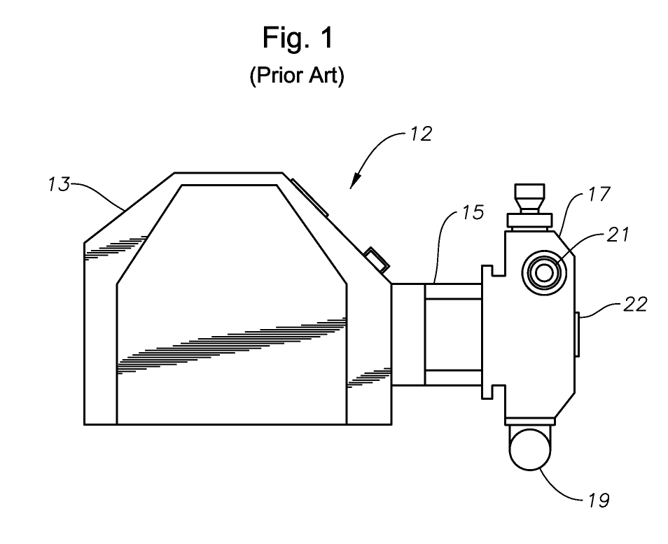

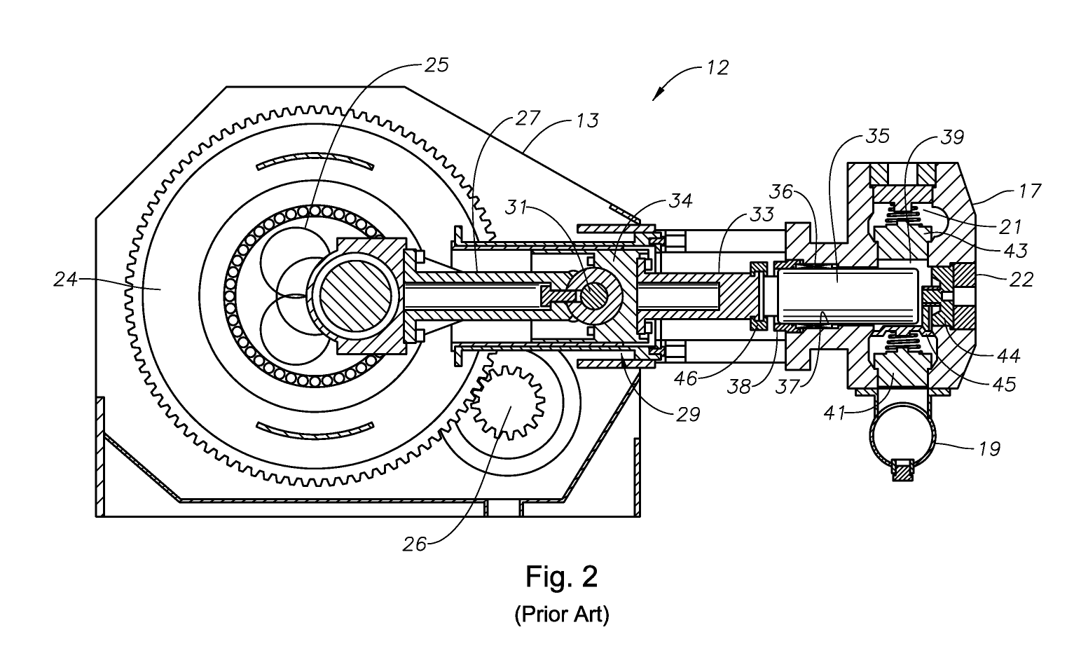

Referring to FIGS. 1 and 2, reciprocating pump assembly or pump 12 includes a crankshaft housing 13 that comprises a majority of the outer surface of reciprocating pump 12. Stay rods 15 connect crankshaft housing 13 to a cylinder housing 17 having a set of cylinders 37 (FIG. 2). Each cylinder 17 is in communication with a fluid inlet 19 and a fluid outlet 21. As shown in FIG. 2, a retaining nut 22 connects to an end of each cylinder 37 opposite the housing that houses the stay rods 15. Pump 12 can be free-standing on the ground, can be mounted to a trailer that can be towed between operational sites, or mounted to a skid such as for offshore operations.

Referring to FIG. 2, a portion of reciprocating pump 12 housed within crankshaft housing 13 is shown in a side partial sectional view. Crankshaft housing 13 houses a crankshaft 25, which is typically mechanically connected to a motor (not shown). The motor rotates crankshaft 25 in order to drive reciprocating pump 12. In one embodiment, crankshaft 25 is cammed so that fluid is pumped from each cylinder 37 at alternating times. As is readily appreciable by those skilled in the art, alternating the cycles of pumping fluid from each of cylinders 37 helps minimize the primary, secondary, and tertiary (et al.) forces associated with reciprocating pump 12.

A gear 24 is mechanically connected to crankshaft 25, that is rotated by the motor through gears 26 and 24. A connector rod 27 is connected to the crankshaft 25 at one end. The connector rod 27 connects to a crosshead 29 through a crosshead wrist pin 31, which holds connector rod 27 longitudinally relative to crosshead 29. The connector rod 27 pivots within a crosshead bushing 34 in the crosshead 29 as crankshaft 25 rotates with the other end of connector rod 27. A pony rod 33 extends from crosshead 29 in a longitudinally opposite direction from crankshaft 25. Connector rod 27 and crosshead 29 convert rotational movement of crankshaft 25 into longitudinal movement of pony rod 33.

A plunger 35 is connected to pony rod 33 for pumping the fluid passing through cylinder 37. Packing 36 surrounds plunger 35. A packing nut 38 is threaded into the cylinder housing 17, and acts to maintain the packing 36 in the proper position within packing bore 37. Cylinder 37 leads to an interior or cylinder chamber 39, which is where plunger 35 pressurizes the fluid being pumped by reciprocating pump 12 (FIG. 1). Cylinder 37 also typically includes an inlet valve 41 and an outlet valve 43. Valves 41 and 43 are usually spring-loaded valves and are actuated by a predetermined differential pressure. Inlet valve 41 actuates to control fluid flow through fluid inlet 19 into cylinder chamber 39, and outlet valve 43 actuates to control fluid flow through fluid outlet 21 from cylinder chamber 39.

Plunger 35 reciprocates, or moves longitudinally toward and away from cylinder chamber 39, as crankshaft 25 rotates. As plunger 35 moves longitudinally away from cylinder chamber 39, the pressure of the fluid inside chamber 39 decreases, creating a differential pressure across inlet valve 41, which actuates valve 41 and allows the fluid to enter cylinder chamber 39 from fluid inlet 19. The fluid being pumped enters cylinder chamber 39 as plunger 35 continues to move longitudinally away from cylinder chamber 39 until the pressure difference between the fluid inside chamber 39 and the fluid in fluid inlet 19 is small enough for inlet valve 41 to actuate to its closed position. As plunger 35 begins to move longitudinally towards cylinder chamber 39, the pressure on the fluid inside of cylinder chamber 39 begins to increase. Fluid pressure inside cylinder chamber 39 continues to increase as plunger 35 approaches cylinder chamber 39 until the differential pressure across outlet valve 43 is large enough to actuate valve 43 and allow the fluid to exit cylinder 17 through fluid outlet 21. In one embodiment, fluid is only pumped across one side of plunger 35, therefore reciprocating pump 12 is a single-acting reciprocating pump.

Maintenance of the pump 12, typically includes repacking of the packing 36 surrounding the plunger 35 and revalving of the inlet and outlet valves 41, 43. To allow repacking or revalving, the pump 12 is disassembled by removing the plunger clamp 46, packing nut 38, suction cover 44, valve stop 45, retaining nut 22, and removing the plunger 35. The connector rod 27 and pony rod 33 can be stroked out to slide the plunger 35 out and provide access to the packing 36 and valves 41, 43. Repacking and revalving, typically require two people as the plunger 35 is heavy and must be re-installed into the pump 12 after maintenance is complete. Frequently, installing the plunger 35 requires maintenance personnel to hammer the plunger into place during installation. This approach to reinstall the plunger 35 can damage pump 12 parts and injure personnel.

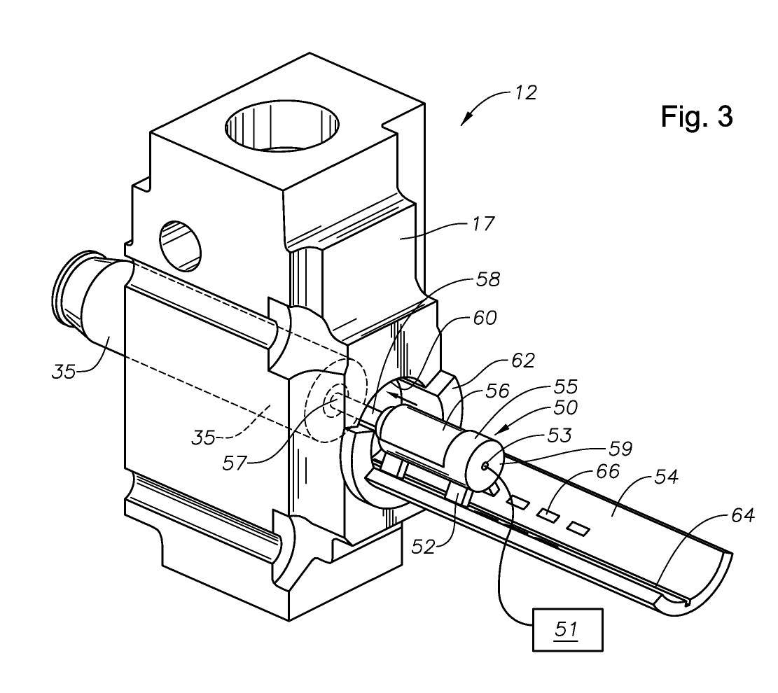

Referring to FIG. 3, an embodiment of a hydraulic installation tool 50 is shown. The hydraulic installation tool can be placed proximately to the pump 12 after maintenance is complete and can be connected to a hydraulic source 51 via a hydraulic connection 53 located on a base 59 of a housing 55 that can support a hydraulic cylinder 56. The connection features can also be incorporated directly onto the hydraulic cylinder 56. The hydraulic installation tool 50 can have a plurality of legs 52 connected to the housing 55 that allow the tool to slidingly engage rails on a rail guide 54 removably attached to cylinder housing 17 via a threaded mating end 62 screwed into the cylinder opening 60. The new packing 38 (FIG. 2) is installed prior to the use of the installation tool 50. The tool 50 includes a hydraulic cylinder 56 with a piston rod 58 that can extend out from the body of the hydraulic cylinder 56 during operation. An engagement end 57 of the piston rod 58 can engage one end of the plunger 35 to force the plunger 35 into the pump cylinder housing 17 through the cylinder opening 60 located where the retaining nut 22 (FIG. 2) was removed.

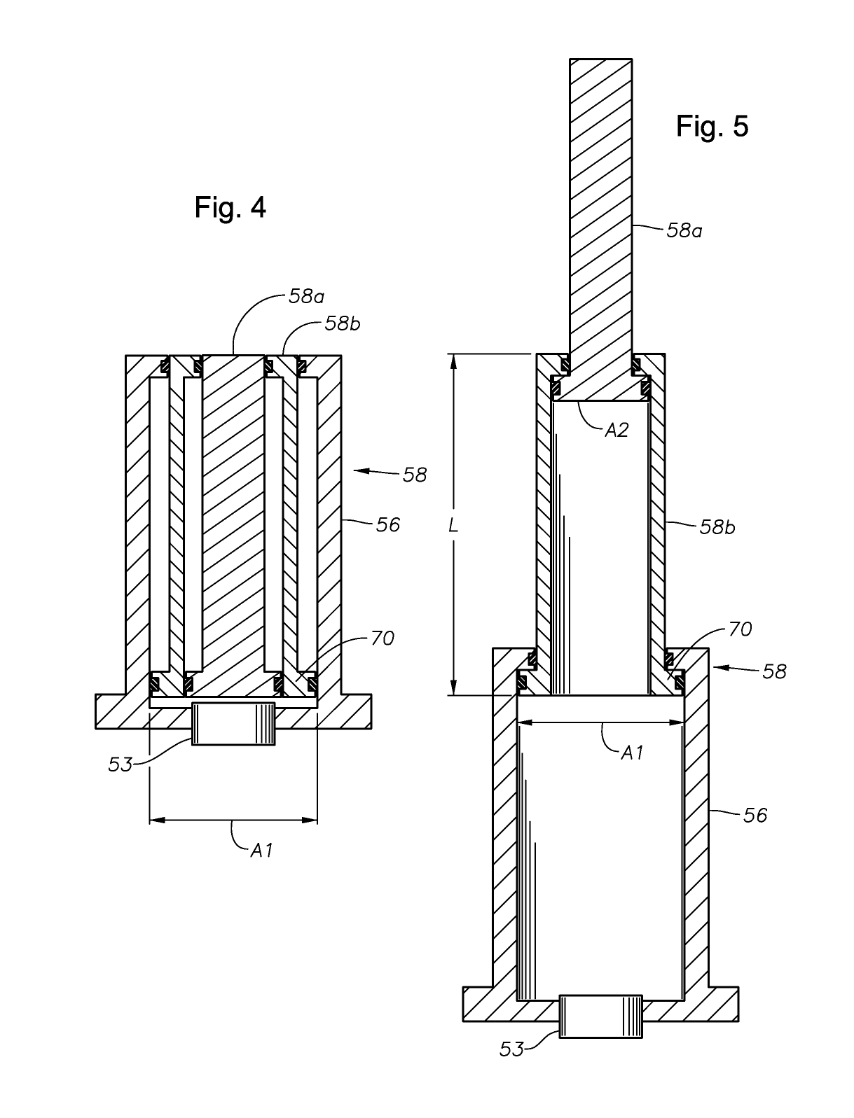

FIGS. 4 and 5 show telescoping stages 58a and 58b of the piston rod 58. The respective lower surfaces of the stage 58b and embedded stage 58a have a combined area of A1. Stage 58b is annular and stage 58a telescopingly extends from within 58b in response to hydraulic fluid acting on area A2 once a flange 70 on an exterior surface of stage 58b contacts a downward facing shoulder within cylinder 56. Although the flange 70 is shown located at a base of stage 58b, flange 70 could be located at any desired point along the length of the stage 58b in order to achieve a desired force, such as for example 2000 lbs, through a desired distance. Once under load from the plunger 35, the piston rod 58 can generate a sufficient force, such as for example, at least 2000 lbs, to push the plunger 35 into the packing 36 (FIG. 2). The 2000 lbs force is only required through approximately one inch, which is why the flange 70 can be located at a point on the stage 58b other than the base. Generating this force is accomplished by supplying hydraulic fluid from the hydraulic source 51 to the hydraulic cylinder 56 through the hydraulic connection 53 acting on the combined area A1 of piston 58a and piston 58b. Piston 58b is limited to deliver a low stroke rate and distance that is required for the initial higher load. Once through the initial stage of the packing 36 (FIG. 2), the force of the hydraulic fluid acts on the smaller area A2 to thereby cause piston rod stage 58a to telescope out at a faster rate than stage 58b. For example, the length L of stage 58 is set so when it is fully extended from the hydraulic cylinder 56, its terminal end is at or past the packing 36. To create the required reaction points, the legs 52 (FIG. 3) can be locked to the rail guide 54 (FIG. 3) in any number of ways. For example, the legs 52 may fit into recesses or slots 66 (FIG. 3) formed on the rail guide 54 (FIG. 3) and the guide 54 can temporarily engage the body of the pump cylinder 17 via the mating end 62. The slots 66 may lockingly secure the legs 52 of the cylinder housing 55 for example, with locking pins (not shown). Alternatively, the legs 52 can lock onto a groove 64 formed along the length of the rail guide 54. The rail guide 54 may also have a concave shape that provides a more effective surface on which to support the installation tool 50. After the plunger 35 is properly in place within the pump cylinder 17, the piston rod 58 can be retracted into the hydraulic cylinder 56. The hydraulic installation tool 50 along with the rail guide 54 can then be removed for storage and the retaining nut 22 placed back on the cylinder opening 60.

Reciprocating pumps 12 are large, and complex pieces of equipment with many parts that may have to be replaced as they wear out. Making the disassembly safer, simpler, and less time consuming is thus desirable because it makes pump maintenance safer and less labor intensive. By using a hydraulic installation tool 50 that can install the plunger 35 back into the pump 12 via hydraulic actuation, the need for manually hammering the plunger 35 into place is eliminated. Thus, the dangerous and labor intensive task of installing the plunger 35 back into the pump 12 after completion of maintenance, is eliminated.

This written description uses examples to disclose the invention, including the best mode, and also enable a person of ordinary skill in the art to practice the invention, including making and using any devices or systems and performing any incorporated methods. These embodiments are not intended to limit the scope of the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A plunger installation tool for maintenance of a reciprocating pump, comprising:
a guide projecting axially from a cylinder opening on the pump;
a hydraulic piston that lockingly engages the guide; and
a piston rod that projects outward from the cylinder opening so that the piston can exert a force on an end of the rod during operation of the installation tool, the piston rod having an engagement end that projects inward into the cylinder opening to engage the plunger and push the plunger into the cylinder opening when the piston rod is advanced into the cylinder opening by the hydraulic piston.

2. The installation tool of claim 1, further comprising:
a circular mating end adapted to engage the cylinder opening on the pump;
a flange that projects axially outward from the mating end and past the cylinder opening, the flange having a lip with an outer diameter larger than the cylinder opening.

3. The installation tool of claim 1, wherein the guide has a semi-circular shape and has an upward facing concave surface.

4. The installation tool of claim 1, further comprises a first telescoping stage and a second telescoping stage.

5. The installation tool of claim 1, wherein the piston rod generates at least 1000 lbs of force, the force transferred axially so that it acts on the plunger.

6. The installation tool of claim 2, wherein the mating end has threads on an exterior surface for threadingly engaging corresponding threads on an interior cylindrical surface of the cylinder opening.

7. The installation tool of claim 1, further comprising at least one leg connected to the hydraulic piston so that the leg can lockingly secure to the guide to provide a reaction point for the installation tool.

8. The installation tool of claim 4, wherein hydraulic fluid in the hydraulic piston acts on an area A1 of the first and second telescoping stage until the first telescoping stage is fully extended, the hydraulic fluid then acting on area A2 of the second telescoping stage to extend the second stage.

9. The installation tool of claim 8, wherein area A1 is larger than area A2 and the second telescoping stage extends out at a faster rate than the first telescoping stage.

10. A plunger installation tool for maintenance of a reciprocating pump, comprising:
a circular mating end adapted to engage a cylinder opening on the pump, the mating end having threads on an exterior surface for threadingly engaging corresponding threads on an interior cylindrical surface of the cylinder opening;
a flange that projects axially outward from the mating end and past the cylinder opening;
a semi-circular rail projecting axially from a portion of the flange and away from the cylinder opening having an upward facing concave surface;
a hydraulic piston that lockingly engages the rail, the piston having at least one leg connected to the hydraulic piston so that the leg can lockingly secure to the rail;
a piston rod that projects outward from the cylinder opening so that the piston can exert a force on an end of the rod during operation of the installation tool, the piston rod having an engagement end that projects inward into the cylinder opening to engage the plunger and push the plunger into the cylinder opening when the piston rod is advanced into the cylinder opening by the hydraulic piston, wherein
the piston rod comprises a first telescoping stage and a second telescoping stage.

11. The installation tool of claim 9, wherein the flange has a lip having an outer diameter larger than the cylinder opening.

12. The installation tool of claim 9, wherein the piston rod generates at least 1000 lbs of force, the force transferred axially so that it acts on the plunger.

13. The installation tool of claim 11, wherein hydraulic fluid in the hydraulic piston acts on an area A1 of the first telescoping stage until the first telescoping stage is fully extended, the hydraulic fluid then acting on area A2 of the second telescoping stage to extend the second stage.

14. The installation tool of claim 13, wherein area A1 is larger than area A2 and the second telescoping stage extends out at a faster rate than the first telescoping stage.

15. A method for installing a plunger during maintenance or assembly of a pump, comprising:
placing a portion of the plunger in a cylinder opening on the pump;
providing a plunger installation tool comprising, a guide that projects axially from the cylinder opening on the pump and a hydraulic piston that lockingly engages the guide;
advancing a piston rod located within the hydraulic piston until an engagement end of the rod engages an end of the plunger;
exerting a force on the plunger via the hydraulic piston acting on the piston rod to thereby push the plunger into a desired position within the cylinder opening; and
removing the plunger installation tool from the cylinder opening.

16. The method of claim 15, further comprising the steps of:
mating an end of the guide to the cylinder opening on the pump.

17. The method of claim 15, further comprising the step of repacking an area surrounding the plunger.

18. The method of claim 16, wherein the step of mating the guide to the cylinder opening comprises screwing a threaded end of the guide to the cylinder opening.
